(19) United States
(12) Patent Application Publication
(10) Pub. No.: US 2023/0347817 A1
(43) Pub. Date: Nov. 2, 2023

(54) WORK VEHICLE

(71) Applicant: KUBOTA CORPORATION, Osaka (JP)

(72) Inventors: Nicholas ALLICOCK, Suwanee, GA (US); John WHITE, Flowery Branch, GA (US); Logan HAYES, Dawsonville, GA (US)

(73) Assignee: KUBOTA CORPORATION, Osaka (JP)

(21) Appl. No.: 17/730,779

(22) Filed: Apr. 27, 2022

(51) Int. Cl. B60Q 3/30; B60P 1/16; B60P 1/28; B60P 1/43

(52) U.S. Cl. CPC B60Q 3/30; B60P 1/16; B60P 1/28; B60P 1/435

(57) ABSTRACT

A work vehicle includes: a carrier box including: a front panel; a floor panel; a pair of left and right side panels; a rear gate supported by the floor panel in such a manner as to be capable of being opened and closed; and a lighting section including: a light configured to emit light backward; and a support panel attached to the front panel and supporting the light.

### TECHNICAL FIELD

The present disclosure relates to a work vehicle such as a utility terrain vehicle (UTV) including a body with a carrier box.

### BACKGROUND ART

UTVs are used as four-wheel drive off-road vehicles for multiple purposes such as farmwork and transportation. A UTV may include a carrier box switchable between a horizontal position and a slanted position with a front portion lifted in response to an operation of a dump cylinder.

US2021/0086843A1, for example, discloses a work vehicle in the form of a UTV including a carrier box with a rear gate disposed at the back end thereof and capable of being opened and closed. The work vehicle disclosed in US2021/0086843A1 includes a single handle outward of a central portion of the rear gate. The rear gate is structured such that a user facing the rear gate can pull the handle toward the user to unlock the rear gate. With the rear gate unlocked as such, the user can cause the rear gate to fall into a horizontal position, in which the carrier box can receive various objects as loaded thereon.

### SUMMARY OF INVENTION

A carrier box may be provided with a winch and configured such that a front portion thereof is liftable for a slanted position in response to an operation of a dump cylinder to allow a heavy object to be pulled with use of the winch to be loaded onto the carrier box. Such loading work may be performed at nighttime, which makes it difficult to operate the winch appropriately or perceive the state of an object to be loaded. While conventional work vehicles may include a backward light, such a light is configured not to illuminate the carrier box, but to emit light backward of the work vehicle. This does not facilitate loading work at nighttime. The above circumstances have led to a demand for a work vehicle that facilitates loading work at nighttime.

In view of the above, a work vehicle according to the present disclosure includes: a front panel; a floor panel; a pair of left and right side panels; a rear gate supported by the floor panel in such a manner as to be capable of being opened and closed; and a lighting section including: a light configured to emit light backward; and a support panel attached to the front panel and supporting the light.

### BRIEF DESCRIPTION OF DRAWINGS

The present disclosure is further described in the detail description which follows, in reference to the noted plurality of drawings by way of non-limiting examples of exemplary embodiments of the present disclosure, in which like reference numerals represent similar parts throughout the several views of the drawings, and wherein:

FIG. 1 is a view of a work vehicle in its entirety as viewed from obliquely backward.

FIG. 2 is a front view of a front panel and a lighting section.

FIG. 3 is a perspective rear view of a front panel and a lighting section.

FIG. 4 is a schematic view of a winch.

FIG. 5A is a diagram schematically illustrating a rear gate in a hold position during an operation of rotationally moving the rear gate.

FIG. 5B is a diagram schematically illustrating a rear gate in an up position during an operation of rotationally moving the rear gate.

FIG. 5C is a diagram schematically illustrating a rear gate in a flat position during an operation of rotationally moving the rear gate.

FIG. 5D is a diagram schematically illustrating a rear gate in a ramp position during an operation of rotationally moving the rear gate.

FIG. 6 is a side view of a work vehicle with a rear gate in a ramp position.

FIG. 7 is an enlarged rear view of a work vehicle with a rear gate in an up position.

### DESCRIPTION OF EMBODIMENTS

The description below deals with a work vehicle as an embodiment of the present disclosure with reference to drawings. The present embodiment described below is, as an example work vehicle, a utility terrain vehicle (UTV) including a body with a carrier box. The present disclosure is, however, not limited to the embodiment below, and may be altered variously within its scope.

The description below uses terms such as “front” and “forward” to refer to the front side in the front-back direction of the body (indicated as “F” in the drawings), terms such as “back” and “backward” to refer to the back side in the front-back direction of the body (indicated as “B” in the drawings), terms such as “left-right direction” and “lateral” to refer to the horizontal direction perpendicular to the front-back direction of the body, terms such as “below” and “downward” to refer to the gravitational direction (indicated with “D” in the drawings), and terms such as “above” and “upward” to refer to the direction opposite to the gravitational direction (indicated with “U” in the drawings).

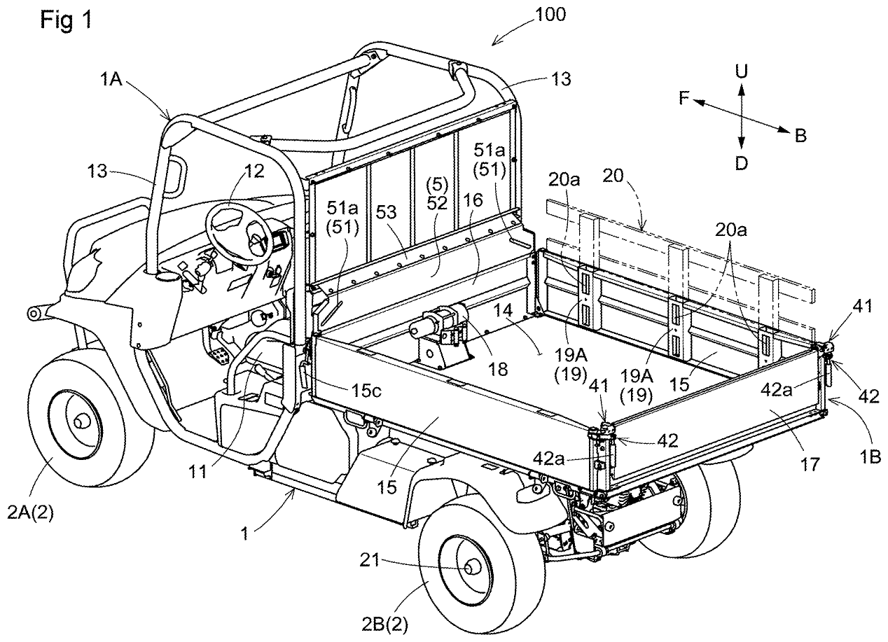

FIG. 1 illustrates a UTV 100 (which is an example of the “work vehicle”) including a body 1 and four wheels 2 (namely, two front wheels 2A and two rear wheels 2B) each supported by the body 1 with a suspension in-between. The UTV 100 is a four-wheel drive vehicle configured such that the wheels 2 are drivable by a power source such as a motor and an internal combustion engine. The UTV 100 is usable for multiple purposes such as farmwork and transportation.

The body 1 is provided with a pair of left and right front wheels 2A at a front portion and a pair of left and right rear wheels 2B at a back portion. The body 1 includes a driver section 1A backward of the front wheels 2A and a carrier box 1B backward of the driver section 1A. The carrier box 1B is configured such that a front portion thereof is liftable for a slanted position in response to an operation of a dump cylinder (that is, the below-described fluid cylinder 31) to allow a load to be dumped backward by its self weight.

The driver section 1A includes a driver's seat 11 for a driver to sit on and a steering wheel 12 positioned forward of the driver's seat 11 and operable to turn the front wheels 2A. The driver section 1A further includes two ROPS frames 13 respectively at the left and right sides of the driver section 1A to protect the driver and any other occupant in the event of a roll-over accident of the body 1.

The carrier box 1B is an open-top box including (i) a floor panel 14 as a bottom wall, (ii) a pair of left and right side panels 15 connected with respective lateral sides of the floor panel 14, (iii) a front panel 16 connected with the front end of the floor panel 14, and (iv) a rear gate 17 connected with the back end of the floor panel 14. The floor panel 14 is a rectangular plate. The side panels 15 are connected respectively with the entire lateral sides of the floor panel 14. The front panel 16 is connected with the entire front side of the floor panel 14. The rear gate 17 is connected with the entire back side of the floor panel 14. The carrier box 1B for the present embodiment has a large capacity. Approximately two-thirds or smaller of its area lies forward of the rear axle 21 for the rear wheels 2B, while approximately one-third or larger of the area lies backward of the rear axle 21.

For normal use, the floor panel 14, the side panels 15, and the front panel 16 are so fixed as to be unmovable relative to one another, and the rear gate 17 is movable rotationally about the back end of the floor panel 14 as a rotary shaft. The rear gate 17 is capable of being restricted in its backward movement with use of wires hung between the respective side panels 15 and the rear gate 17. The side panels 15 are each provided with a lock member 15c unlockable to allow the corresponding side panel 15 to move rotationally outward relative to the front panel 16.

The carrier box 1B is provided with a winch 18 fixed to the floor panel 14 or the front panel 16 at a central position of the connection between the floor panel 14 and the front panel 16. The winch 18 is forward relative to the floor panel 14 to allow a largest possible load capacity for the carrier box 1B. The winch 18 may alternatively be absent.

The side panels 15 are provided with an engagement section 19 to which a plate-shaped member 20 such as a wooden frame is detachably attachable. The engagement section 19 is in the form of a plurality of (six for the present embodiment) insertion hole forming members 19A which are provided for each of the side panels 15 and in each of which a protrusion 20a of a plate-shaped member 20 is insertable. The side panels 15 are each provided with insertion hole forming members 19A at least one of which is backward of the rear axle 21. The insertion hole forming members 19A are provided for the side panels 15 in left-right symmetry.

The side panels 15 are each fixed to the front panel 16 with use of a lock member 15c. The front panel 16 is fixed to the floor panel 14 with use of fastener members such as bolts. The front panel 16 is provided with a lighting section 5 including a light 51 configured to emit light backward and a support panel 52 detachably attached to the front panel 16 and supporting the light 51. The light 51 is at such a position on the lighting section 5 as to illuminate the winch 18. The light 51 is in the form of a pair of LED units 51a each including a plurality of linearly arranged LEDs (light emitting diodes). The LED units 51a are disposed at respective upper corners of the support panel 52, and each have an inclined arrangement. The light 51 does not necessarily include LEDs, and may be any illuminator. Further, the support panel 52 may alternatively be integral with the front panel 16 or welded or otherwise fixed to the front panel 16.

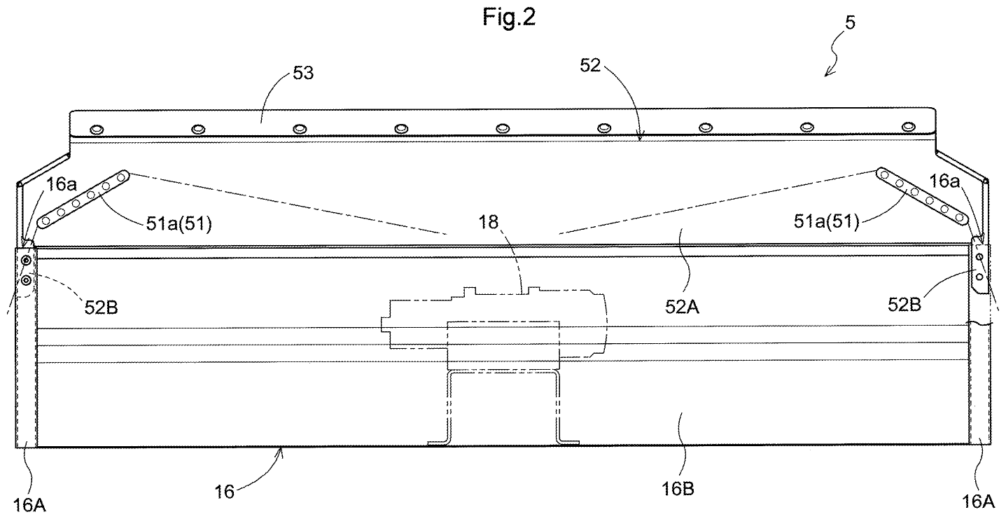

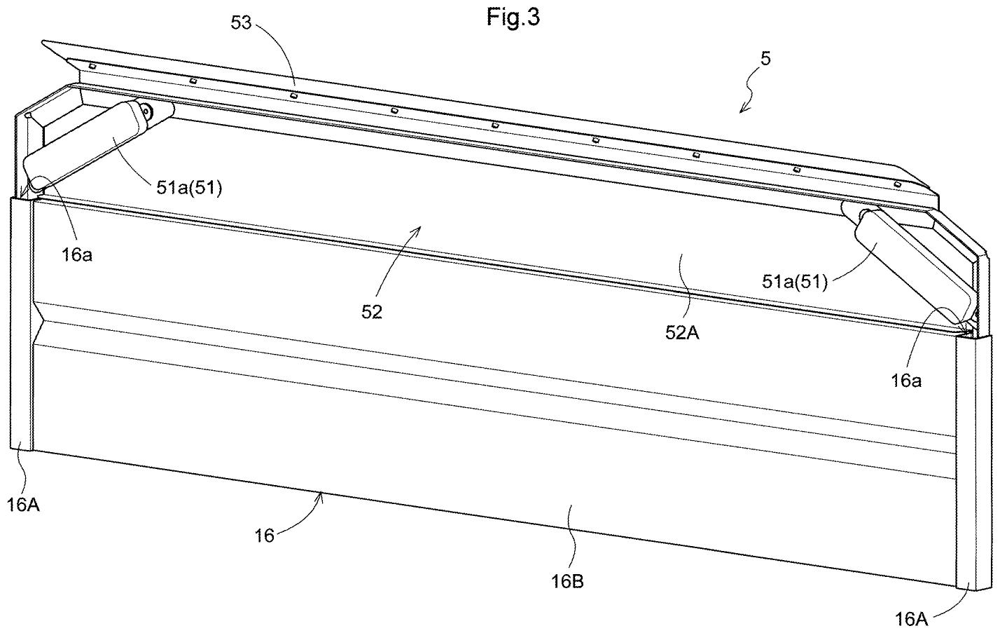

As illustrated in FIGS. 2 and 3, the front panel 16 includes (i) a pair of prism-shaped members 16A each fixed to a front end portion of the corresponding side panel 15 with use of a lock member 15c and (ii) a plate member 16B connecting the prism-shaped members 16A with each other and integral with the prism-shaped members 16A. The prism-shaped members 16A are each in the form of a hollow, angular bar configured to receive a projection 52B of the support panel 52 as inserted. Specifically, the front panel 16 has, at each of an upper left end portion and upper right end portion thereof, a through hole 16a configured to receive a projection 52B of the support panel 52 as inserted.

The support panel 52 includes (i) a body plate 52A to which the LED units 51a are fixed and (ii) a pair of projections 52B projecting from respective lower left and right ends of the body plate 52A and integral with the body plate 52A. The LED units 51a are each fixed to an upper corner of the body plate 52A and shaped in a straight line so inclined that a portion closer to the corresponding lateral end of the body plate 52A is lower in position. The LED units 51a are, in other words, arranged in left-right symmetry as if to cut off the respective upper corners of the body plate 52A. Inserting the projections 52B into the respective through holes 16a in the upper portions of the front panel 16 and fixing the projections 52B with use of fastener members such as bolts results in the support panel 52 providing an additional height for the front panel 16. Further, the LED units 51a, each of which is fixed to an upper corner of the body plate 52A and shaped in an inclined straight line, are capable of illuminating the entire carrier box 1B, with particular brightness for the winch 18 and the area therearound.

The lighting section 5 includes an inclined plate 53 coupled to an upper portion of the support panel 52 with use of fastener members such as bolts and extending forward of the support panel 52. The inclined plate 53 extends across the gap between the driver section 1A and the carrier box 1B (specifically, the front panel 16) and obliquely upward from the carrier box 1B toward the driver section 1A. The inclined plate 53, which extends forward of the support panel 52 as described above, prevents an object in the carrier box 1B from falling into the gap in front of the front panel 16.

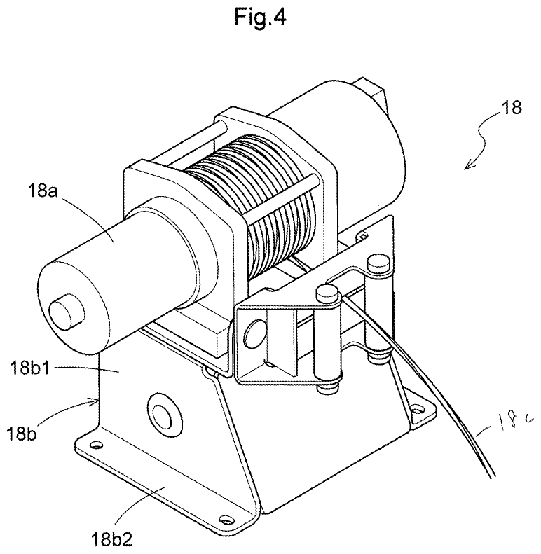

As illustrated in FIG. 4, the winch 18 includes a motor 18a, a frame 18b supporting the motor 18a, and a wire 18c drivable by the motor 18a with a deceleration mechanism in-between. The frame 18b is in the shape of an L-shaped box, and includes vertical portions 18b1 fixed at a central position of the plate member 16B of the front panel 16 and bottom portions 18b2 fixed at a front position of the floor panel 14. The winch 18 as installed on the carrier box 1B is lower in position than the front panel 16 and the side panels 15.

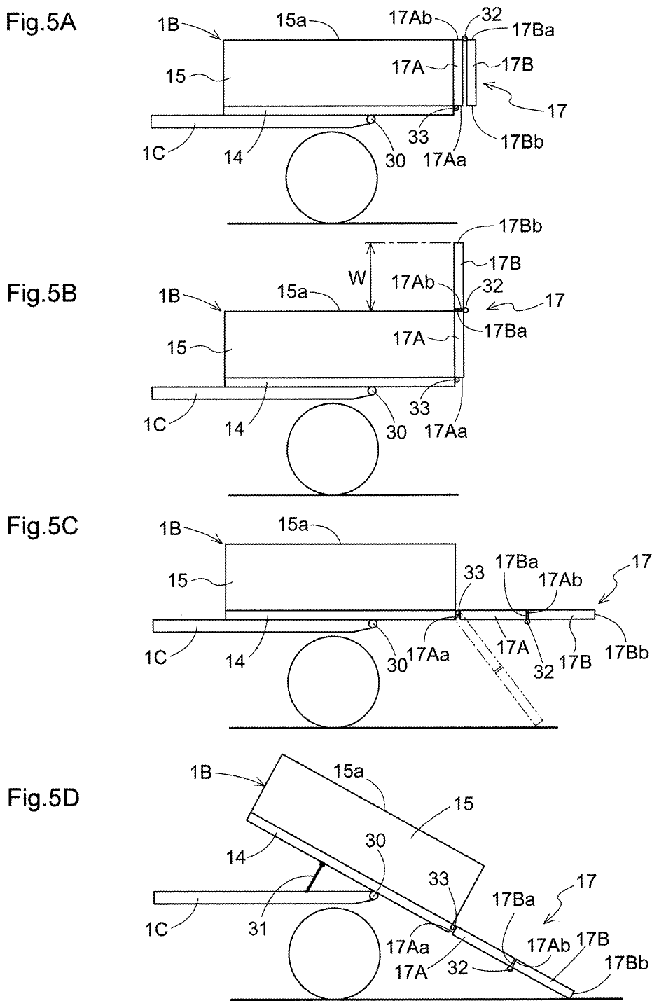

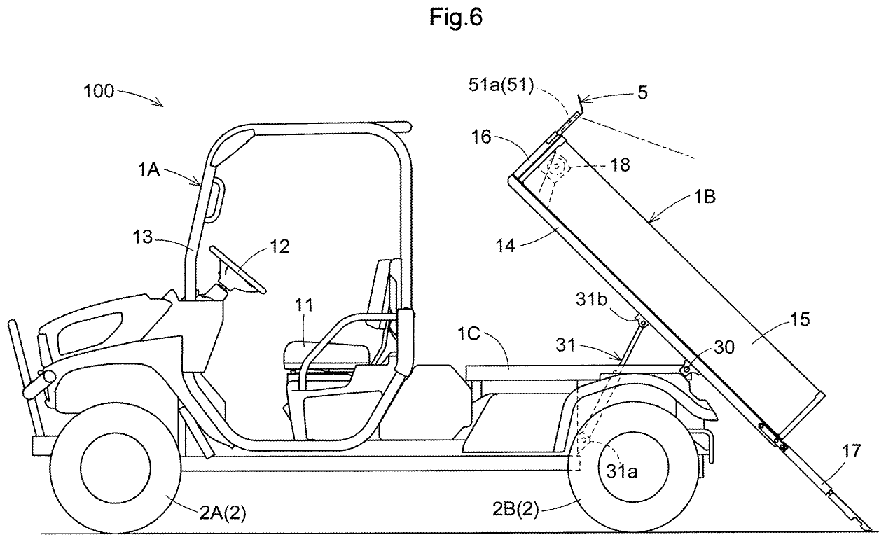

As illustrated in FIGS. 5A to 5D and 6, the rear gate 17 includes a first panel 17A connected with the floor panel 14 in such a manner as to move rotationally and a second panel 17B connected with the first panel 17A in such a manner as to move rotationally. The first panel 17A includes a first end 17Aa connected with the back end of the floor panel 14 in such a manner as to move rotationally and a second end 17Ab with which the second panel 17B is connected in such a manner as to move rotationally. The second panel 17B includes a third end 17Ba connected with the first panel 17A in such a manner as to move rotationally and a fourth end 17Bb as an open end.

As illustrated in FIG. 6, the carrier box 1B is connected with a frame 1C of the body 1 with use of a hinge 30 in such a manner as to move rotationally. The hinge 30 connects the lower face of the floor panel 14 with the frame 1C. The floor panel 14 is capable of moving rotationally about the hinge 30 up to an angle of 45 degrees to 60 degrees relative to the frame 1C. The UTV 100 includes a fluid cylinder 31 configured to lift and lower the carrier box 1B relative to the frame 1C. The fluid cylinder 31 includes a first end 31a connected with the frame 1C and a second end 31b connected with the lower face of the floor panel 14.

FIGS. 5A to 5D schematically illustrate how the rear gate 17 is moved rotationally. FIG. 5A illustrates a hold position, in which the rear gate 17 is folded into two (namely, the first panel 17A and the second panel 17B) and closes the back portion of the carrier box 1B. FIG. 5B illustrates an up position, in which the second panel 17B is over the first panel 17A so that the rear gate 17 has an additional height. FIG. 5C illustrates a flat position, in which the first panel 17A and the second panel 17B are aligned with the floor panel 14 and parallel to the ground surface. FIG. 5D illustrates a ramp position, in which the first panel 17A and the second panel 17B are aligned with the floor panel 14 and inclined to be close to the ground surface.

The hold position illustrated in FIG. 5A is such that the second end 17Ab and the third end 17Ba are at the same level as the respective top walls 15a of the side panels 15, while the first end 17Aa and the fourth end 17Bb are at the same level as the floor panel 14. In the hold position, in other words, the second end 17Ab and the third end 17Ba are above the first end 17Aa and the fourth end 17Bb.

The up position illustrated in FIG. 5B is such that the second panel 17B has been moved rotationally counterclockwise by 180 degrees about a first rotary shaft 32 from the hold position so that the second end 17Ab and the third end 17Ba face each other and that the fourth end 17Bb is above the third end 17Ba and separated therefrom by the panel width W. In the up position, in other words, the fourth end 17Bb is above the respective top walls 15a of the side panels 15, and the rear gate 17 closes the back portion of the carrier box 1B and has a height increased by the panel width W.

The flat position illustrated in FIG. 5C is such that the first panel 17A and the second panel 17B have been moved rotationally clockwise by 90 degrees about a second rotary shaft 33 from the up position to be aligned with the floor panel 14. In the flat position, in other words, the fourth end 17Bb of the second panel 17B is below the respective top walls 15a of the side panels 15, and the back portion of the carrier box 1B is open. The flat position allows an object to be loaded onto the carrier box 1B from backward. The flat position may alternatively be such that the first panel 17A and the second panel 17B have been moved rotationally clockwise by 90 degrees about the second rotary shaft 33 with the rear gate 17 folded into two.

The ramp position illustrated in FIG. 5D is such that the carrier box 1B has been moved rotationally about the hinge 30 from the flat position relative to the frame 1C with use of the fluid cylinder 31 to be so obliquely inclined that the carrier box 1B has a lifted front portion and that the fourth end 17Bb of the second panel 17B is close to the ground surface. In the ramp position, in other words, the fourth end 17Bb of the second panel 17B is below the frame 1C, and the back portion of the carrier box 1B is open. The ramp position allows an object to be pulled with use of the winch 18 onto the carrier box 1B. The carrier box 1B may additionally be in an intermediate position between the flat position illustrated in FIG. 5C and the ramp position illustrated in FIG. 5D. The intermediate position is, as indicated with double-dashed chain lines in FIG. 5C, such that the first panel 17A and the second panel 17B have been moved rotationally clockwise about the second rotary shaft 33 from the flat position so that the floor panel 14 is parallel to the ground surface and that the first panel 17A and the second panel 17B are inclined to be close to the ground surface.

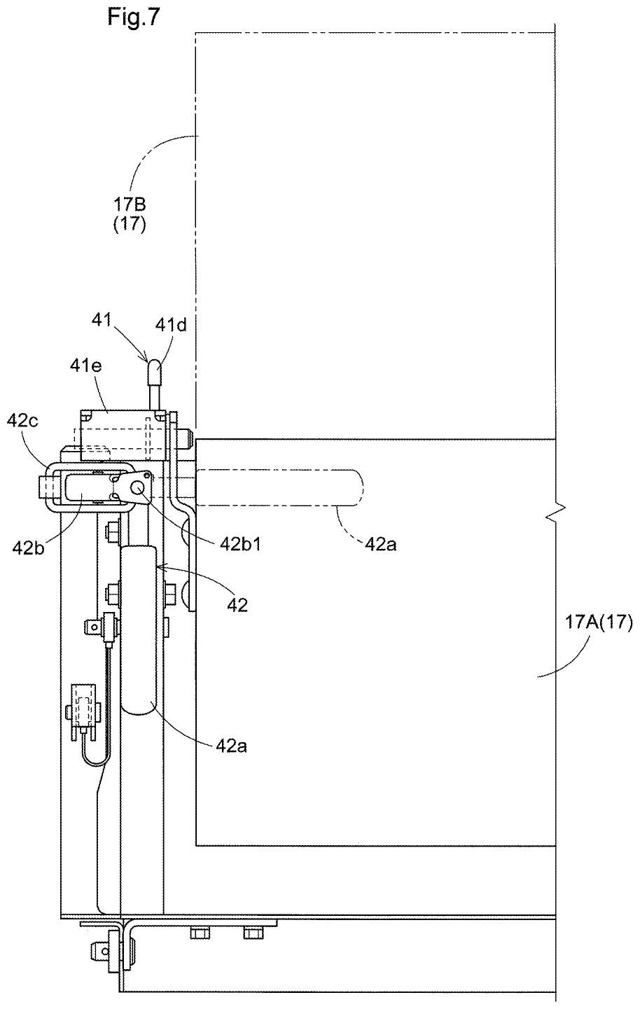

FIG. 7 is an enlarged rear view of the rear gate 17 in the up position illustrated in FIG. 5B. The rear gate 17 is provided with a pair of first lock mechanisms 41 configured to restrict rotational movement of the second panel 17B with the second panel 17B over the first panel 17A. The rear gate 17 is also provided with a pair of second lock mechanisms 42 configured to restrict rotational movement of the first panel 17A. As illustrated in FIGS. 1 and 7, the second lock mechanisms 42 include a pair of operation bars 42a so positioned at opposite lateral end portions of the first panel 17A as not to hinder rotational movement of the second panel 17B while the second lock mechanisms 42 is in the locking state. The pair of first lock mechanisms 41 and the pair of second lock mechanisms 42 are both at opposite lateral end portions of the rear gate 17 in left-right symmetry.

The first lock mechanisms 41 each include an operation pin 41d and a support plate 41e in which the operation pin 41d is inserted. Moving the operation pin 41d toward and away from the second panel 17B switches the first lock mechanism 41 between a locking state and an unlocking state.

The second lock mechanisms 42 each include an operation bar 42a as a handle, a support member 42b supporting the operation bar 42a in such a manner that the operation bar 42a is movable rotationally, and a loop-shaped latch 42c engageable with the support member 42b. The operation bar 42a is movable rotationally about the rotary shaft 42b1 of the support member 42b along the outer face of the first panel 17A. Moving the operation bar 42a, positioned at a lateral end portion of the first panel 17A and oriented in the up-down direction, rotationally in the left-right direction and then pulling the operation bar 42a backward moves the support member 42b and the latch 42c outward, rendering the second lock mechanism 42 in the unlocking state. In this state, pushing the operation bar 42a forward moves the support member 42b and the latch 42c inward to achieve a locked state. In the locked state, the operation bar 42a is movable rotationally in the left-right direction about the rotary shaft 42b1 of the support member 42b and also in the up-down direction.

The embodiment described above is configured such that the lighting section 5 includes a support panel 52 attached to the front panel 16 and supporting the light 51. This allows the light 51 to illuminate the loading space of the carrier box 1B. Further, when the carrier box 1B is moved in response to an operation of the fluid cylinder 31 into a slanted position with a front portion lifted, the support panel 52 is moved together with the front panel 16. This allows the light 51 to keep illuminating the loading space. The embodiment described above is, in other words, configured such that the carrier box 1B is capable of being lifted and lowered into a slanted position with use of a fluid cylinder 31 and that the lighting section 5 illuminates a predetermined area of the carrier box 1B regardless of the position into which the carrier box 1B has been lifted or lowered. This allows the lighting section 5 to keep illuminating the loading space when the carrier box 1B is moved with use of the fluid cylinder 31 from a horizontal position into a slanted position with a front portion lifted. This in turn facilitates loading work at nighttime. Further, the support panel 52 is detachable from the front panel 16, and may be removed during the daytime so that the UTV 100 has a lighter weight and a better fuel efficiency.

The light 51 is at such a position on the lighting section 5 as to illuminate the winch 18. This allows an operator to easily operate the winch 18, which would otherwise be difficult to operate at nighttime. The light 51 is, in particular, in the form of a pair of inclined LED units 51a at respective upper corners of the support panel 52. This allows an area requiring illumination to be illuminated in a concentrated manner.

### Alternative Embodiments

(1) The embodiment described above is configured such that the side panels 15 are connected respectively with the entire lateral sides of the floor panel 14. The side panels 15 may alternatively be connected respectively with portions of the lateral sides of the floor panel 14. The embodiment described above is configured such that the front panel 16 is connected with the entire front side of the floor panel 14. The front panel 16 may alternatively be connected with a portion of the front side of the floor panel 14. The embodiment described above is configured such that the rear gate 17 is connected with the entire back side of the floor panel 14. The rear gate 17 may alternatively be connected with a portion of the back side of the floor panel 14. In other words, the carrier box 1B, which has a first dimension from its front end to its back end, may alternatively include a left side panel 15, a right side panel 15, and a floor panel 14 each extending in the front-back direction over at least a portion of the first dimension, a front panel 16 positioned at the front end of the carrier box 1B and extending over at least a portion of a second dimension between the left side panel 15 and the right side panel 15, and a rear gate 17 positioned at the back end of the carrier box 1B, extending over at least a portion of the second dimension, and movable to close the space defined by the left side panel 15, the right side panel 15, and the floor panel 14.

(2) The embodiment described above is configured such that the side panels 15 are provided with an engagement section 19 to which a plate-shaped member 20 such as a wooden frame is detachably attachable. The plate-shaped member 20 may, however, be replaced with any other height extension that the user prepares as desired to provide an additional height for each side panel 15. The engagement section 19 may be in the form of a hole(s) in an upper portion of a sufficiently thick side panel 15.

(3) The embodiment described above is configured such that the light 51 is in the form of a pair of inclined LED units 51a at respective upper corners of the support panel 52. The light 51 may, however, be in any form as long as the light 51 is at such a position on the lighting section 5 as to illuminate the winch 18. Further, the support panel 52 may alternatively be detachably attached to the ROPS frames 13.

(4) The work vehicle described above is not limited to a utility terrain vehicle (UTV), and may alternatively be, for example, a vehicle with a carrier box such as a pickup truck as long as the vehicle is capable of, for example, farmwork and transportation.

### [Outline of Embodiment Described Above]

The description below outlines the work vehicle described above as an embodiment.

(1) A work vehicle, including: a carrier box including: a front panel; a floor panel; a pair of left and right side panels; a rear gate supported by the floor panel in such a manner as to be capable of being opened and closed; and a lighting section including: a light configured to emit light backward; and a support panel attached to the front panel and supporting the light.

With the above configuration, the lighting section includes a support panel attached to the front panel and supporting the light. This allows the light to illuminate the loading space of the carrier box. Further, when the carrier box is moved in response to an operation of the dump cylinder into a slanted position with a front portion lifted, the support panel is moved together with the front panel. This allows the light to keep illuminating the loading space. This in turn facilitates loading work at nighttime.

(2) The work vehicle may be configured such that the support panel is detachable from the front panel.

With the above configuration, the support panel is detachable from the front panel. The support panel may thus be removed during the daytime so that the work vehicle has a lighter weight and a better fuel efficiency.

(3) The work vehicle may be configured such that the carrier box further includes a winch at a position on a boundary between the floor panel and the front panel, and the light is at such a position on the lighting section as to illuminate the winch.

With the above configuration, the light is at such a position on the lighting section as to illuminate the winch. This allows an operator to easily operate the winch, which would otherwise be difficult to operate at nighttime.

(4) The work vehicle may be configured such that the light includes a pair of inclined LED units at respective upper corners of the support panel.

With the above configuration, the light is in the form of a pair of inclined LED units at respective upper corners of the support panel. This allows an area requiring illumination to be illuminated in a concentrated manner.

(5) The work vehicle may be configured such that the support panel includes a projection insertable in a through hole in an upper portion of the front panel so that the support panel provides an additional height for the front panel.

With the above configuration, the support panel includes a projection insertable in a through hole in an upper portion of the front panel. This allows the support panel to be attached easily.

(6) The work vehicle may further include: an inclined plate coupled to an upper portion of the support panel and extending forward of the support panel.

With the above configuration, the work vehicle includes an inclined plate extending forward of the support panel. This prevents an object in the carrier box from falling into the gap in front of the front panel.

(7) The work vehicle may be configured such that the carrier box is capable of being lifted and lowered into a slanted position with use of a fluid cylinder, and the lighting section illuminates a predetermined area of the carrier box regardless of a position into which the carrier box has been lifted or lowered.

The above configuration allows the lighting section to keep illuminating the loading space when the carrier box is moved with use of the fluid cylinder from a horizontal position into a slanted position with a front portion lifted.

The arrangements disclosed for the above embodiments (including the alternative embodiments; hereinafter the same applies) may each be combined with an arrangement disclosed for another embodiment, as long as such a combination does not cause a contradiction. Further, the embodiments disclosed in the present specification are mere examples. The present disclosure is not limited to those embodiments, and may be altered as appropriate, as long as such an alteration does not result in a failure to attain an object of the present disclosure.

1. A work vehicle, comprising:
a carrier box including:
a front panel;
a floor panel;
a pair of left and right side panels;
a rear gate supported by the floor panel in such a manner as to be capable of being opened and closed; and
a lighting section including:
a light configured to emit light backward; and
a support panel attached to the front panel and supporting the light.

2. The work vehicle according to claim 1, wherein
the carrier box further includes a winch at a position on a boundary between the floor panel and the front panel, and
the light is at such a position on the lighting section as to illuminate the winch.

3. The work vehicle according to claim 1, wherein
the light includes a pair of inclined LED units at respective upper corners of the support panel.

4. The work vehicle according to claim 1, wherein
the support panel includes a projection insertable in a through hole in an upper portion of the front panel so that the support panel provides an additional height for the front panel.

5. The work vehicle according to claim 4, further comprising:
an inclined plate coupled to an upper portion of the support panel and extending forward of the support panel.

6. The work vehicle according to claim 1, wherein
the carrier box is capable of being lifted and lowered into a slanted position with use of a fluid cylinder, and
the lighting section illuminates a predetermined area of the carrier box regardless of a position into which the carrier box has been lifted or lowered.
